(19) United States
(12) Patent Application Publication
(10) Pub. No.: US 2022/0266831 A1
(43) Pub. Date: Aug. 25, 2022

(54) METHOD, SYSTEM AND COMPUTER PROGRAM PRODUCT FOR AUTOMATICALLY ADAPTING AT LEAST ONE DRIVING ASSISTANCE FUNCTION OF A VEHICLE TO A TRAILER OPERATING STATE

(71) Applicant: Dr. Ing. h.c. F. Porsche Aktiengesellschaft, Stuttgart (DE)

(72) Inventor: Tobias Donnevert, Stuttgart (DE)

(21) Appl. No.: 17/668,492

(22) Filed: Feb. 10, 2022

(30) Foreign Application Priority Data
Feb. 23, 2021 (DE) 10 2021 104 243.7

(51) Int. Cl. B60W 30/182; B60W 30/12; B60W 30/14; B60W 30/16; B60W 30/18; B60W 10/20; B60W 10/18; G06V 20/56; G06V 10/82; H04W 4/44

(52) U.S. Cl. CPC B60W 30/182; B60W 30/12; B60W 30/143; B60W 30/16; B60W 30/18163; B60W 10/20; B60W 10/18; G06V 20/56; G06V 10/82; H04W 4/44; B60W 2300/14; B60W 2420/42; B60W 2420/52; B60W 2556/45

(57) ABSTRACT

A method is provided for automatically adapting at least one driving assistance function of a vehicle to a trailer operating state of the vehicle. The method includes using at least one camera of a sensor and camera device for recording data in a recording region in which a trailer could be situated and communicating the data to an evaluation module. The method then includes evaluating the data using evaluation algorithms of the evaluation module for determining whether a trailer is connected to the vehicle and a trailer operating state thus exists. The method proceeds by communicating a trailer operating state from the evaluation module to at least one driving assistance module with at least one driving assistance function if a trailer operating state is determined. The method concludes using the driving assistance module for calculating a mode of the respective driving assistance function adapted to the trailer operating state.

### CROSS REFERENCE TO RELATED APPLICATION

This application claims priority under 35 USC 119 to German Patent Appl. No. 10 2021 104 243.7 filed on Feb. 23, 2021, the entire disclosure of which is incorporated herein by reference.

### BACKGROUND

### Field of the Invention

The invention relates to a method, a system and a computer program product for automatically adapting at least one driving assistance function of a vehicle to a trailer operating state of the vehicle.

### Related Art

Modern vehicles are equipped with a large number of driving assistance systems or driving assistance functions to assist the driver when driving and to increase the driver's safety. In this regard, parking assistance systems are known and assist the driver during parking and maneuvering by means of optical and acoustic signals. In particular, ultrasonic sensors and camera systems are used for this purpose. The camera system can comprise a reversing camera or a plurality of individual cameras fit to the front, the sides and the rear of the vehicle. An all-round view is calculated from these cameras, and the image is displayed on a screen in the vehicle. Guide lines indicating the distance to an object such as a wall or another vehicle may be depicted in the image.

Driving assistance systems for speed and distance regulation are known and may be used with lane keeping and lane changing assistants. In these cases, a specific maximum speed can be set and is not exceeded as long as the speed limiting function is activated. Radar sensors and camera systems are used for the distance regulation and involve setting a specific distance with respect to a vehicle ahead. As a result, the distance with respect to vehicles ahead and with respect to vehicles in the side region can be monitored. Thus, it is possible to increase driving convenience and safety particularly during journeys on the interstate and during overtaking maneuvers.

Some driving assistance systems calculate optimum acceleration and deceleration values on the basis of navigation data of the route and correspondingly activate the engine/motor and the brake mechanisms of the vehicle by means of a control device. The course of the route may be known by virtue of navigation data. Accordingly, data concerning the road conditions and topography, such as possible bends and grades, can be retrieved and used for the calculations. Data concerning the current traffic situation, such as data recorded by radar and camera systems of the vehicle, can be taken into account. As a result, it is possible to increase safety, particularly when traveling on country roads, and to optimize the fuel consumption.

Driving assistance systems available at the present time are designed only for the vehicle per se and do not consider whether the vehicle is connected to a trailer, such as a transport trailer, a mobile home or a horsebox by means of a trailer coupling that forms a combination. The vehicle state and the driving properties change as a result of trailer operation, and the driving assistance systems are not designed to account for trailer operation.

DE 44 18 044 A1 describes an electronically controlled speed limiter for a tractor-trailer combination where the speed limiter is activated by the coupling of a trailer. When a trailer is coupled to a motor vehicle that is otherwise permitted without a speed limit, a cruise control situated in the tractor vehicle is activated via a contact in the electronic connection socket of the tractor vehicle and limits the legally permitted maximum speed of 80 km/h electronically to an achievable maximum of 100 km/h.

DE 10 2012 016 941 A1 describes a method for operating a motor vehicle with a trailer. The method involves determining whether there is a connection between the motor vehicle and at least one transport device by means of the hitching device. If there is a connection, predefined different values of a speed limit for driving operation of the motor vehicle are defined.

DE 102 42 112 A1 describes a method and a device for monitoring the speed of a vehicle depending on a state variable of the vehicle such as trailer operation.

U.S. Pat. No. 9,428,190 describes a vehicle having a speed regulating system. The speed of the vehicle is reduced to lower the brake temperature if the vehicle is coupled to a trailer and a brake temperature is higher than a predefined threshold value.

It is an object of the invention to provide a method, a system and a computer program product for automatically adapting at least one driving assistance function of a vehicle to a trailer operating state of the vehicle, thereby increasing safety and convenience during driving of the vehicle with a trailer.

### SUMMARY OF INVENTION

One aspect of the invention relates to a method for automatically adapting at least one driving assistance function of a vehicle to a trailer operating state that occurs when a trailer is connected to the vehicle. The method comprises using at least one camera of a sensor and camera device to record data in a recording region in which a trailer could be situated. The method then includes communicating the data to an evaluation module and evaluating the data by means of evaluation algorithms of the evaluation module to determine whether a trailer is connected to the vehicle and thus whether a trailer operating state exists. The method then includes communicating a trailer operating state from the evaluation module to at least one driving assistance module that has at least one driving assistance function if a trailer operating state was determined; and using the driving assistance module to adapt a mode of the respective driving assistance function to the trailer operating state.

In one embodiment, the driving assistance function comprises at least one control parameter for at least one control device for at least one component of the vehicle. The component of the vehicle may be an engine/motor, a brake system and/or a steering system.

In one embodiment the driving assistance module comprises a driving assistance function for speed and distance regulation, and/or for lane keeping and lane changing, and/or for calculating optimum acceleration and deceleration values on the basis of navigation data for route.

The evaluation algorithms of the evaluation module may comprise neural networks, such as a convolutional neural network.

The sensor and camera device of some embodiments comprises optical RGB cameras, and/or action cameras, and/or LIDAR (Light detection and ranging) systems with optical distance and speed measurement, and/or stereoscopic optical camera systems, and/or ultrasonic systems, and/or radar systems, and/or infrared cameras.

In a further embodiment, the evaluation module is configured to be connected to a cloud computing infrastructure via a mobile radio connection.

The trailer of some embodiments is provided with a retrofittable sensor and camera module that is connected to the evaluation module by a mobile radio connection.

The invention also relates to a system for automatically adapting at least one driving assistance function of a vehicle to a trailer operating state in which a trailer is connected to the vehicle. The system comprises a sensor and camera device, an evaluation module and at least one driving assistance module. The sensor and camera device is configured to record data in a recording region in which a trailer could be situated, and to communicate the data to the evaluation module. The evaluation module is configured to evaluate the data by means of evaluation algorithms to determine whether a trailer is connected to the vehicle and thus whether a trailer operating state exists. The existence of a trailer operating state can be communicated to at least one driving assistance module. The driving assistance module is configured to calculate a mode of the respective driving assistance function adapted to the trailer operating state.

In one embodiment, the driving assistance function comprises at least one control parameter for at least one control device for at least one component of the vehicle. The component of the vehicle may be an engine/motor and/or a brake system and/or a steering system.

The driving assistance module may comprise a driving assistance function for speed and distance regulation, and/or for lane keeping and lane changing, and/or for calculating optimum acceleration and deceleration values on the basis of navigation data along the route.

In a further embodiment, the evaluation algorithms of the evaluation module may comprise neural networks, in particular a convolutional neural network.

The sensor and camera device may comprise at least one of optical RGB cameras, action cameras, LIDAR (Light detection and ranging) systems with optical distance and speed measurement, stereoscopic optical camera systems, ultrasonic systems, radar systems, and/or infrared cameras.

The evaluation module may be connected to a cloud computing infrastructure via a mobile radio connection.

In one embodiment, the trailer has a retrofittable sensor and camera module, that is connected to the evaluation module by means of a mobile radio connection.

The invention also relates to a computer program product, comprising an executable program code configured such that, when executed, it carries out the method in accordance with the invention.

The invention is explained in greater detail below on the basis of an exemplary embodiment illustrated in the drawings.

### BRIEF DESCRIPTION OF THE DRAWINGS

FIG. 1 Is a schematic illustration of a vehicle with a trailer.

FIG. 2 is a schematic illustration of a system for automatically adapting at least one driving assistance function of a vehicle to a trailer operating state;

FIG. 3 is a flow diagram for elucidating the individual method steps of a method according to the invention;

FIG. 4 shows a computer program product in accordance with one embodiment of the invention.

### DETAILED DESCRIPTION

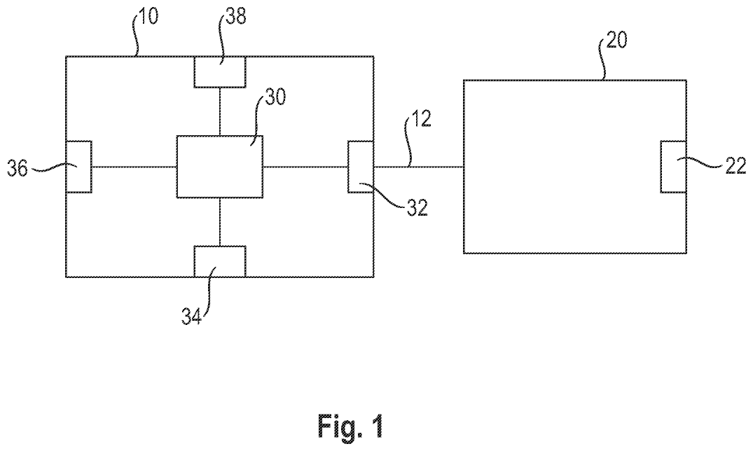

FIG. 1 schematically illustrates a vehicle 10 in a trailer operating state. The vehicle 10 is connected by a trailer coupling 12 to a trailer 20, such as a transport trailer, a mobile home or a horsebox. The vehicle 10 comprises a sensor and camera device 30 with various sensor systems and cameras 32, 34, 36, 38 arranged at different positions in or on the vehicle 10. The cameras 32, 34, 36, 38 may be RGB cameras in the visible range with the primary colors of blue, green and red. UV cameras in the ultraviolet range and/or IR cameras in the infrared range can be provided as night vision devices. The cameras differ in terms of their recording spectrum and can image different lighting conditions in their respective recording region.

The recording frequency of the cameras 32, 34, 36, 38 can be designed for fast speeds of the motor vehicle 10 and can record image data with a high image recording frequency. In addition, provision can be made for the cameras 32, 34, 36, 38 to automatically start the image recording process if an areally significant change arises in the recording region of the respective camera 32, 34, 36, 38, for example if an object such as another vehicle or a roadway boundary such as marking stripes appears in the recording region. Thus, selective data acquisition is made possible and only relevant image data are recorded so that computing capacities can be utilized more efficiently.

The cameras 32, 34, 36, 38 arranged in the exterior region of the vehicle 10 may be weatherproof action cameras. Action cameras have wide-angle fisheye lenses, thus making it possible to achieve a visible radius of more than 90°. In particular, the recording radius can reach 180°, such that two cameras are sufficient for recording the surroundings of the vehicle 10 in a surrounding circle of 360°. Action cameras can usually record videos in full HD (1920×1080 pixels), but it is also possible to use action cameras in ultra HD or 4K (at least 3840×2160 pixels), thereby resulting in a significant increase in the image quality. The image recording frequency is usually 60 frames per second in 4K and up to 240 frames per second in full HD. An integrated image stabilizer also can be provided. Moreover, action cameras often are equipped with an integrated microphone, such that acoustic signals can be recorded. Differential signal processing methods can be used to mask out background noises in a targeted manner.

Furthermore, LIDAR (Light detection and ranging) systems with optical distance and speed measurement, stereoscopic optical camera systems, ultrasonic systems and/or radar systems can be used as sensors.

Thus, a trailer 20 that is connected to the vehicle is captured by the sensor and camera device 30.

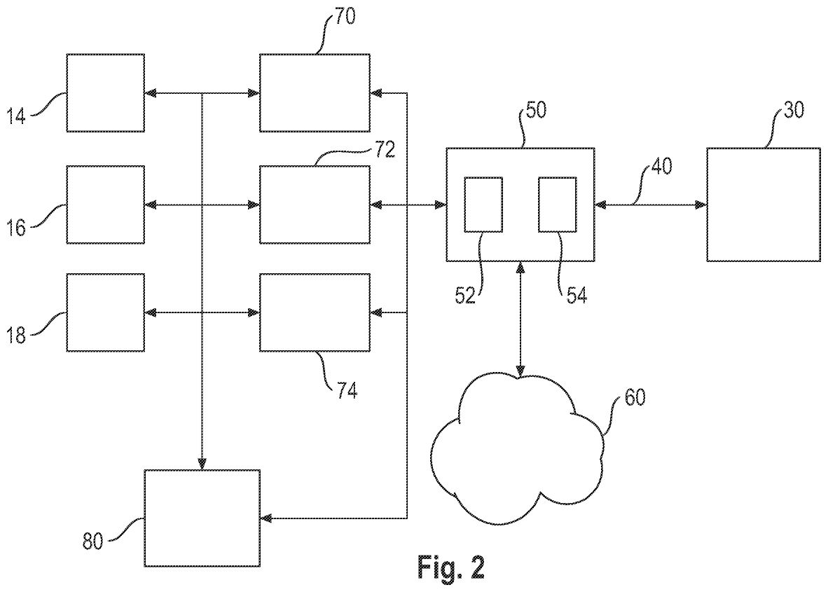

FIG. 2 illustrates a system 100 according to the invention for automatically adapting at least one driving assistance function. The data 40 recorded by the sensor and camera device 30 of FIG. 1 are forwarded to an evaluation module 50 of FIG. 2. The evaluation module 50 comprises an integrated or assigned processor 52 and/or one or more storage units 54.

Therefore, in association with the invention, a “module” can be understood to mean for example a processor and/or a storage unit for storing program instructions. By way of example, the module is specifically designed to execute the program instructions in such a way as to implement or realize the method according to the invention or a step of the method according to the invention.

In association with the invention, a “processor” can be understood to mean for example a machine or an electronic circuit or a powerful computer. A processor can be in particular a central processing unit (CPU), a microprocessor or a microcontroller, for example an application-specific integrated circuit or a digital signal processor, possibly in combination with a storage unit for storing program instructions. Moreover, a processor can be understood to mean a virtualized processor, a virtual machine or a soft CPU. It can for example also be a programmable processor that is equipped with configuration steps for carrying out the stated method according to the invention or is configured with configuration steps in such a way that the programmable processor realizes the features according to the invention of the method, of the component, of the modules, or of other aspects and/or partial aspects of the invention. Moreover, highly parallel computing units and powerful graphics modules can be provided. In addition, provision can be made for the processor 52 not to be arranged in the vehicle 10, but rather to be integrated in a cloud computing infrastructure 60.

In association with the invention, a “storage unit” or “storage module” and the like can be understood to mean for example a volatile memory in the form of main memory (random-access memory, RAM) or a permanent memory such as a hard disk or a data carrier or e.g. an exchangeable storage module. However, the storage module can also be a cloud-based storage solution.

In association with the invention, the recorded data 40 should be understood to mean both the raw data and already conditioned data from the recording results of the sensor and camera device 30. In particular, the data 40 are image data, wherein the data formats of the image data are preferably embodied as tensors. However, it is also possible to use other image formats.

The sensor and camera device 30 and/or a control device assigned thereto and/or the evaluation module 50 can have mobile radio modules of the 5G standard. 5G is the fifth generation mobile radio standard and, in comparison with the 4G mobile radio standard, is distinguished by higher data rates of up to 10 Gbits/sec, the use of higher frequency ranges such as, for example, 2100, 2600 or 3600 megahertz, an increased frequency capacity and thus an increased data throughput and real-time data transmission, since up to one million devices per square kilometer can be addressed simultaneously. The latencies are a few milliseconds to less than 1 ms, with the result that real-time transmissions of data and calculation results are possible. The image data 40 recorded by the sensor and camera device 30 can be transmitted in real time to the cloud computing infrastructure 60, where the corresponding analysis and calculation are carried out. The analysis and calculation results can be transmitted back to the vehicle 10 in real time and can thus be rapidly integrated in action instructions to the driver or in automated driving functions. This speed when communicating data is necessary if cloud-based solutions are intended to be used for the processing of the image data 40. Cloud-based solutions afford the advantage of high and thus fast computing powers. In order to protect the connection to a cloud computing infrastructure 60 by means of a mobile radio connection, in particular cryptographic encryption methods are provided.

If the evaluation module 50 is integrated in the vehicle 10, AI hardware acceleration such as the Coral Dev Board is advantageously used for the processor 52 in order to enable processing in real time. This is a microcomputer with a tensor processing unit (TPU), as a result of which a pretrained software application can evaluate up to 70 images per second.

For the evaluation of the data 40, the processor 52 uses one or more evaluation algorithms to determine from the recorded data 40 whether a trailer 20 is connected to the vehicle 10. In particular, algorithms of artificial intelligence such as neural networks can be used for the image processing.

A neural network has neurons arranged in layers and interconnected in various ways. A neuron is able to receive information from the outside or from another neuron at its input, to assess the information in a specific manner and to forward the information in changed form at the neuron output to a further neuron, or to output it as a final result. Hidden neurons are arranged between the input neurons and output neurons. Depending on the type of network, there may be plural layers of hidden neurons. They ensure that the information is forwarded and processed. Output neurons finally yield a result and output the result to the outside world. Arranging and linking the neurons gives rise to different types of neural networks such as feedforward networks, recurrent networks or convolutional neural networks. The networks can be trained by means of unsupervised or supervised learning.

The convolutional neural network has a plurality of convolutional layers and is very well suited to machine learning and applications with artificial intelligence (AI) in the field of image recognition. The functioning of a convolutional neural network is modeled to a certain extent on biological processes and the structure is comparable to the visual cortex of the brain. The individual layers of the CNN are the convolutional layer, the pooling layer and the fully connected layer. The pooling layer follows the convolutional layer and may be present multiply in succession in this combination. Since the pooling layer and the convolutional layer are locally connected subnetworks, the number of connections in these layers remains limited and in a manageable framework even in the case of large input volumes. A fully connected layer forms the termination. The convolutional layer is the actual convolutional level and is able to recognize and extract individual features in the input data. During image processing, these may be features such as lines, edges or specific shapes. The input data are processed in the form of tensors such as a matrix or vectors.

The convolutional neural network (CNN) therefore affords numerous advantages over conventional non-convolutional neural networks. It is suitable for machine learning and artificial intelligence applications with large volumes of input data, such as in image recognition. The network operates reliably and is insensitive to distortions or other optical changes. The CNN can process images recorded under different lighting conditions and from different perspectives. It nevertheless recognizes the typical features of an image. Since the CNN is divided into a plurality of local partly connected layers, it has a significantly lower storage space requirement than fully connected neural networks. The convolutional layers drastically reduce the storage requirements. The training time of the convolutional neural network is likewise greatly shortened. CNNs can be trained very efficiently with the use of modern graphics processors.

In the case where the evaluation module 50 has recognized a trailer operating state of the vehicle 10, this result is passed on to one or more driving assistance modules 70, 72, 74. In this regard, one driving assistance module 70 may have a driving assistance function for speed and distance regulation, and is connected to the engine/motor 14, the brake system 16 and/or the steering system 18 and/or further vehicle components via control devices. If trailer operation is recognized, the driving assistance module 70 automatically chooses a speed limit in line with the maximum speed allowed for a trailer 20 of 80 km/h or 100 km/h, for example, and passes the maximum speed on to the corresponding control devices. Since the invention provides for the evaluation module 50, on the basis of the algorithms used by it, to be able to distinguish between different types of trailers 20 such as, for example, a simple transport trailer for transporting bicycles or a mobile home or a horsebox, for each of which different maximum speeds are provided, the correct maximum speed can be selected automatically. The maximum speed may be displayed to the driver on a user interface 80. The user interface 80 may be a display having a touchscreen.

Another driving assistance module 72 comprises a lane keeping and lane changing function. It is known that a lane change on multilane expressways constitutes a risk situation. During trailer operation, this risk increases once again since the dimensions of the combination consisting of vehicle 10 and trailer 20 have increased and the driving properties therefore change. Upon trailer operation being recognized, the driving assistance module 72 automatically chooses a different mode of steering assistance, for example, and/or outputs acoustic or optical warning signals. Since the driving assistance module 72 having a lane keeping and lane changing function is advantageously connected to a rain sensor as well, in the wet or during heavy rain it is possible to provide an additional speed limit during trailer operation. In particular, the distance with respect to other vehicles, both with respect to a vehicle ahead and with respect to the vehicles in the adjacent lanes in the case of multilane highways, can be modified in the trailer operating state since the collision behavior would change on account of the increased mass and thus weight of the combination. An optical or acoustic warning can again be output via the user interface 80, but also by way of warnings in the exterior mirror on the driver's side of the vehicle 10.

The driving assistance module 74 can be configured to calculate optimum acceleration and deceleration values on the basis of navigation data for the next kilometers of the route and to activate the engine/motor 14 and the brake system 16 accordingly by means of a control device. The course of the route is known by virtue of the navigation data. Thus, data concerning the road conditions and topography, such as possible bends and grades, can be retrieved and used for the calculation. Data concerning the current traffic situation can be recorded by means of the sensor and camera device 30 of the vehicle 10 and also can be taken into account. The driving assistance module 74 automatically chooses a mode of calculating the optimum acceleration and deceleration values that accounts for the trailer 20 if the trailer operation has been recognized. As a result, it is possible to optimize the fuel consumption and to increase safety particularly when traveling on country roads.

The driving assistance modules 70, 72, 74 also can apply artificial intelligence algorithms for the calculation of the corresponding driving assistance functions. In particular, algorithms with optimization functionalities, such as genetic and evolutionary algorithms, can be used.

Image signals from the trailer 20 that are recorded by the sensor and camera device 30, such as the camera 32, can be displayed on the screen of the user interface 80. As a result, the driver of the vehicle 10 can see the trailer 20 while driving. This may be expedient if the trailer 20 is a transport trailer and is loaded with bulky goods, such as construction materials. Objects frequently come off transport trailers. Thus, the driver can observe the screen to determine the position of objects on the transport trailer and can move to a parking position if the driver is given the impression that the objects should be lashed more securely. This significantly increases safety during the transport of objects on a transport trailer. Changes in the position of the objects transported on the transport trailer can be identified by the evaluation module 50 by using image processing algorithms. An indication signal then can be output to the driver via the user interface 80. The image of the trailer 20 can be displayed automatically on the screen.

The camera 32 can be a night vision assistant and may comprise a thermal imaging camera. As a result, the position of the objects transported by the transport trailer can be observed even at night, thereby significantly increasing safety during night journeys with a trailer 20. This may be expedient for horse trailers, since it is possible to observe the behavior of the horses on the trailer 20 that is a partly opened.

The trailer 20 itself may be provided with a sensor and camera module 22. The sensor and camera module 22 may be a mobile, retrofittable module that can be connected to the trailer 20 as necessary, for example via a magnetic connection. In particular, the sensor and camera module 22 can be fit in the rear region of the trailer 20 and can thus record data of the traffic behind. The recorded data are communicated to the evaluation module 50 via a mobile radio connection and the evaluation result is passed on to the driving assistance modules 70, 72, 74.

In the case of closed trailers 20, such as horseboxes, provision can be made for fitting a sensor and camera module 22 in the interior of the trailer 20. The sensor and camera module 22 can transmit a permanent video signal from the interior of the trailer 20, and this video signal being displayed on the screen of the user interface 80. This may be expedient during long journeys of show horses, since in this way the driver can ascertain how the horse is behaving in the trailer. It may also be expedient to provide a temperature sensor, since the temperature in the horsebox may change during the journey and constitutes an important factor for the wellbeing of the horse. The data of the temperature sensor are likewise communicated to the evaluation module 50.

The trailer coupling 12 can be provided with pressure sensors, and data from the pressure sensors can be communicated to the evaluation module 50. As a result, the weight of the trailer 20 can be estimated, which alongside the dimensions (length, width, height) of the trailer 20 has an influence on the driving properties and the maneuverability of the combination of vehicle 10 and trailer 20.

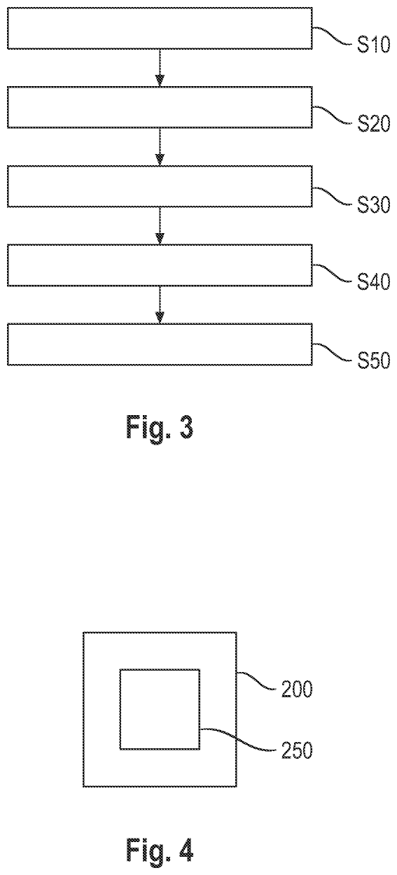

A method for automatically adapting at least one driving assistance function of a vehicle 10 to a trailer operating state of the vehicle 10 when a trailer 20 is connected to the vehicle 10 may comprise the following method steps, as shown in FIG. 3:

Step S10 includes recording data 40 by at least one camera 32 of a sensor and camera device 30 in a recording region in which a trailer 20 could be situated.

Step S20 includes communicating the data 40 to an evaluation module 50.

Step S30 includes using the evaluation module 50 for evaluating the data 40 by means of evaluation algorithms to determine whether a trailer 20 is connected to the vehicle 10 and a trailer operating state thus exists.

Step S40 includes using the evaluation module 50 for communicating a trailer operating state to at least one driving assistance module 70, 72, 74 with at least one driving assistance function if a trailer operating state was determined.

Step S50 includes using the driving assistance module 70, 72, 74 for calculating a mode of the respective driving assistance function adapted to the trailer operating state.

The invention makes it possible to significantly increase safety when driving a combination of a vehicle 10 and a trailer 20, since the driving assistance functions are automatically adapted with regard to their control parameters to the changed driving properties of the combination. For this purpose, the available sensor and camera system 30 of the vehicle is used to record data 40 from the trailer 20. The data are evaluated in the evaluation module 50 to determine whether a trailer 20 is connected to the vehicle. In the case of a trailer operating state, the driving assistance modules 70, 72, 74 are notified that the vehicle 10 is connected to a trailer 20. The driving assistance modules 70, 72, 74 modify their respective driving assistance functions in such a way that they are optimally adapted to the trailer operating state. This automatic adaptation significantly increases both convenience and safety during the driving of a vehicle 10 with a trailer 20.

### REFERENCE SIGNS

10 Vehicle
12 Trailer coupling
14 Engine/Motor
16 Brake system
18 Steering system
20 Trailer
22 Sensor and camera module
30 Sensor and camera device
32 Camera, sensor
34 Camera, sensor
36 Camera, sensor
38 Camera, sensor
40 Data
50 Evaluation module
52 Processor
54 Storage unit
60 Cloud computing infrastructure
70 Driving assistance module
72 Driving assistance module
74 Driving assistance module
80 User interface
100 System
200 Computer program product
250 Program code

What is claimed is:

1. A method for automatically adapting at least one driving assistance function of a vehicle (10) to a trailer operating state of the vehicle (10) where a trailer (20) is connected to the vehicle (10), comprising:
recording (S10), by means of at least one camera (32) of a sensor and camera device (30), data (40) in a recording region in which a trailer (20) could be situated;
communicating (S20) the data (40) to an evaluation module (50);
using evaluation algorithms of the evaluation module (50) for evaluating (S30) the data (40) to determine whether a trailer (20) is connected to the vehicle (10) and a trailer operating state thus exists;
communicating (S40) a trailer operating state from the evaluation module (50) to at least one driving assistance module (70, 72, 74) with at least one driving assistance function if a trailer operating state was determined;
using the driving assistance module (70, 72, 74) for calculating (S50) a mode of the respective driving assistance function adapted to the trailer operating state.

2. The method of claim 1, wherein the driving assistance function comprises at least one control parameter for at least one control device for at least one component of the vehicle (10), wherein the component of the vehicle (10) is an engine/motor (14) and/or a brake system (16) and/or a steering system (18).

3. The method of claim 1, wherein the driving assistance module (70, 72, 74) comprises a driving assistance function for speed and distance regulation, and/or for lane keeping and lane changing, and/or for calculating optimum acceleration and deceleration values on the basis of navigation data for a route.

4. The method of claim 1, wherein the evaluation algorithms of the evaluation module (50) comprise neural networks.

5. The method of claim 1, wherein the sensor and camera device (30) comprises optical RGB cameras (32, 34, 36, 38), and/or action cameras, and/or LIDAR (Light detection and ranging) systems with optical distance and speed measurement, and/or stereoscopic optical camera systems, and/or ultrasonic systems, and/or radar systems, and/or infrared cameras.

6. The method of claim 1, further comprising connecting the evaluation module (50) to a cloud computing infrastructure (60) via a mobile radio connection.

7. The method of claim 1, further comprising connecting a retrofittable sensor and camera module (22) on the trailer (20) to the evaluation module (50) by means of a mobile radio connection.

8. A system (100) for automatically adapting at least one driving assistance function of a vehicle (10) to a trailer operating state of the vehicle (10) that exists when a trailer (20) is connected to the vehicle (10), the system comprising:
a sensor and camera device (30) that is configured to record data (40) in a recording region in which the trailer (20) is situated when the vehicle (10) is in the trailer operating state;
an evaluation module (50) configured to evaluate the data (40) by means of evaluation algorithms in order to determine whether a trailer (20) is connected to the vehicle (10) and thus confirm whether the trailer operating state exists; and
at least one driving assistance module (70, 72, 74) that is configured to calculate a mode of the respective driving assistance function adapted to the trailer operating state.

9. The system (100) of claim 8, wherein the driving assistance function comprises at least one control parameter for at least one control device for at least one component of the vehicle (10), wherein the component of the vehicle (10) is an engine/motor (14) and/or a brake system (16) and/or a steering system (18).

10. The system (100) of claim 8, wherein the driving assistance module (70, 72, 74) comprises a driving assistance function for speed and distance regulation, and/or for lane keeping and lane changing, and/or for calculating optimum acceleration and deceleration values on the basis of navigation data of a route.

11. The system (100) of claim 8, wherein the evaluation algorithms of the evaluation module (50) comprise neural networks.

12. The system (100) of claim 8, wherein the sensor and camera device (30) comprises optical RGB cameras (32, 34, 36, 38), and/or action cameras, and/or LIDAR (Light detection and ranging) systems with optical distance and speed measurement, and/or stereoscopic optical camera systems, and/or ultrasonic systems, and/or radar systems, and/or infrared cameras.

13. The system (100) of claim 8, wherein the evaluation module (50) is connected to a cloud computing infrastructure (60) via a mobile radio connection.

14. The system (100) of claim 8, wherein the trailer (20) is provided with a retrofittable sensor and camera module (22) that is connected to the evaluation module (50) by means of a mobile radio connection.

15. A computer program product (200), comprising an executable program code (250) configured such that, when executed, it carries out the method of claim 1.
